(19) United States
(12) Patent Application Publication
(10) Pub. No.: US 2012/0143953 A1
(43) Pub. Date: Jun. 7, 2012

(54) APPARATUS AND METHOD FOR RECEIVING AND TRASMITTING MULTIMEDIA CONTENTS

(75) Inventors: Sung Hei KIM, Daejeon (KR); Wook HYUN, Daejeon (KR); Chang Kyu LEE, Daejeon (KR); Shin Gak KANG, Daejeon (KR)

(73) Assignee: Electronics and Telecommunications Research Institute, Daejon (KR)

(21) Appl. No.: 13/310,950

(22) Filed: Dec. 5, 2011

(30) Foreign Application Priority Data
Dec. 6, 2010 (KR) 10-2010-0123790

(51) Int. Cl. G06F 15/16

(52) U.S. Cl. 709/204

(57) ABSTRACT

Disclosed is a method for receiving a multimedia content between peers on a peer-to-peer network, including: establishing a neighbor connection relationship which is a relationship to interactively transmit and receive the multimedia content, with the other peer on the peer-to-peer network; establishing a donator connection relationship to receive the multimedia content from the other peer, based on a donator approval request message transmitted to the other peer; receiving a multimedia content piece related message from the other peer based on the established donator connection relationship; and receiving a required multimedia content piece from the other peer according to a result of parsing the multimedia content piece related message.

### CROSS-REFERENCE TO RELATED APPLICATIONS

This application claims priority to and the benefit of Korean Patent Application No. 10-2010-0123790 filed in the Korean Intellectual Property Office on Dec. 6, 2010, the entire contents of which are incorporated herein by reference.

### TECHNICAL FIELD

The present invention relates to a method for providing a multimedia streaming service through a peer-to-peer network which is a cooperative network between application programs operating in a user terminal.

### BACKGROUND

At present, a peer-to-peer network for providing a multimedia streaming service can be largely divided into a tree type and a mesh type.

First, in the tree type peer-to-peer network, the service can be provided by a simple method, but dependency on a predetermined node is such large that when a node is erroneous, all nodes that receive data from the node cannot receive a normal service for a predetermined time.

In addition, in the mesh type peer-to-peer network, dependency on the predetermined node is low, but control traffic for requesting and exchanging consistently possessed data with other nodes frequently occurs.

### SUMMARY OF THE INVENTION

The present invention has been made in an effort to provide a method for reducing control traffic between peers by dividing a relationship between two predetermined peers into a neighbor connection relationship and a donator connection relationship in a mesh type peer-to-peer network that decreases dependency on a predetermined peer.

An exemplary embodiment of the present invention provides a method for receiving a multimedia content between peers on a peer-to-peer network, including: establishing a neighbor connection relationship which is a relationship to interactively transmit and receive the multimedia content, with the other peer on the peer-to-peer network; establishing a donator connection relationship to receive the multimedia content from the other peer, based on a donator approval request message transmitted to the other peer; receiving a multimedia content piece related message from the other peer based on the established donator connection relationship; and receiving a required multimedia content piece from the other peer according to a result of parsing the multimedia content piece related message.

When the multimedia content piece related message is a new multimedia content piece reception notification message, the receiving of the multimedia content piece based on the donator connection relationship may include: judging whether the new multimedia content piece is required; and transmitting a new multimedia piece request message to the other peer when the new multimedia content piece is required.

The establishing of the neighbor connection relationship may include: transmitting an overlay information request message to an overlay management server; parsing a received overlay information message based on the overlay information request message; and establishing the neighbor connection relationship with the other peer by referring to overlay information acquired by parsing the received overlay information message.

The method for receiving a multimedia content may further include receiving a predetermined multimedia content piece from the other peer based on the neighbor connection relationship.

Another exemplary embodiment of the present invention provides a method for transmitting a multimedia content between peers on a peer-to-peer network, including: establishing a neighbor connection relationship which is a relationship to interactively transmit and receive the multimedia content, with the other peer on the peer-to-peer network; receiving a donator approval request message from the other peer; judging whether to serve as a donator based on the received donator approval request message; transmitting a donator approval notification message to the other peer and establishing a donator connection relationship to provide the multimedia content to the other peer when serving as the donator is judged; and transmitting a multimedia content piece to the other peer based on the donator connection relationship.

The transmitting to the other peer may include: receiving a new multimedia content piece from a streaming server or the other peer; transmitting a reception notification message for the new multimedia content piece to the other peer, and transmitting the new multimedia content piece to the other peer when a new multimedia content piece request message is received based on the reception notification message.

Yet another exemplary embodiment of the present invention provides an apparatus for processing a multimedia content on a peer-to-peer network, including: a neighbor peer processing unit establishing a neighbor connection relationship which is a relationship to interactively transmit and receive the multimedia content, with the other peer on the peer-to-peer network; a benefit peer processing unit transmitting a donator approval request message to the other peer having the neighbor connection relationship; and a content processing unit processing the multimedia content received through the donator connection relationship when a donator connection relationship to receive the multimedia content from the other peer through the donator approval request message is established with the other peer.

The content processing unit may include a content piece processing unit restoring a multimedia content piece received from the other peer to all multimedia contents.

The apparatus for processing a multimedia content may further include a donator peer processing unit judging whether to approve a donator based on the donator approval request message received from the other peer having the neighbor connection relationship and transmitting the donator approval notification message to the other peer when serving as the donator is approved according to a judgment result.

The neighbor peer processing unit may request a required multimedia content piece to the other peer based on at least one information of overlay information received from an overlay management server or multimedia content piece status information possessed by the other peer.

The present invention provides the following effects.

First, since dependency on a predetermined peer becomes low in a mesh type peer-to-peer network, it is possible to minimize an influence on a multimedia streaming service even though a problem occurs in the predetermined peer.

Second, when a predetermined peer receives a multimedia content piece from the other peer that has a donator connection relationship, it is possible to minimize a control traffic amount as compared with a case where the peer receives the multimedia content piece through a neighbor connection relationship in order to receive the multimedia streaming service.

Third, the number of donators can be designated as one or more when receiving the multimedia streaming service and does not depend on one peer like an existing tree type.

Fourth, by continuously verifying a new peer even in the donator connection relationship, when a peer which is good to operate as a donator exists, the donator can be added or changed, such that in a peer-to-peer network environment which cannot be stable due to frequent joining/disjoining of peers, the multimedia streaming service can be provided more effectively and stably.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram of a mesh type peer-to-peer network in which a relationship between two peers is constituted by neighbors and donators according to an exemplary embodiment of the present invention.

FIG. 2 is a block diagram of a peer for a peer-to-peer based multimedia streaming service according to an exemplary embodiment of the present invention.

FIG. 3 is a procedure diagram showing an example of a procedure for receiving signaling and a multimedia streaming service for a case where a new peer 305 joins in a multimedia streaming service according to an exemplary embodiment of the present invention.

FIG. 4 is a procedure diagram showing an example of a procedure for receiving signaling and a multimedia streaming service for switching a neighbor connection relationship to a donator connection relationship according to an exemplary embodiment of the present invention.

FIG. 5 is a flowchart illustrating a process of establishing a neighbor connection relationship according to an exemplary embodiment of the present invention.

FIG. 6 is a flowchart illustrating a process of establishing a donator connection relationship according to an exemplary embodiment of the present invention.

FIG. 7 is a flowchart for illustrating a method for one peer to receive and process a connection relationship related message from the other peer according to an exemplary embodiment of the present invention.

FIG. 8 is a flowchart for illustrating a method for one peer to receive and process a multimedia content piece related message from the other peer according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

Exemplary embodiments of the present invention may be implemented by various means. For example, the exemplary embodiments of the present invention may be implemented firmware, software, or a combination thereof, or the like.

In the implementation by the hardware, a method according to exemplary embodiments of the present invention may be implemented by application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the implementation using the firmware or the software, a method according to exemplary embodiments of the present invention may be implemented by modules, procedures, functions, or the like, that perform functions or operations described above. Software codes are stored in a memory unit and may be driven by a processor. The memory unit is disposed in or out the processor and may transmit and receive data to and from the well-known various units.

Throughout the specification, when a predetermined portion is described to be “connected to” another portion, it includes a case where the predetermined portion is electrically connected to the other portion by disposing still another predetermined portion there between, as well as a case where the predetermined portion is directly connected to the other portion. Also, when the predetermined portion is described to include a predetermined constituent element, it indicates that unless otherwise defined, the predetermined portion may further include another constituent element, not precluding the other constituent element.

Also, the term module described in the present specification indicates a single unit to process a predetermined function or operation and may be configured by hardware or software, or a combination of hardware and software.

Specific terms are provided to help understandings of the present invention. The use of the specific terms may be changed into other forms without departing from the technical idea of the present invention.

The present invention provides a configuration method of a peer-to-peer network serving as a neighbor connection relationship and a donator connection relationship in order to effectively provide a multimedia streaming service. In the present invention, a user receive as many multimedia content pieces as possible by operating a neighbor connecting step in order to receive the multimedia streaming service through a peer (terminal) and establishes the donator connection relationship to receive new content information whenever a new content is generated by designating some peers as donator peers when the multimedia streaming service is stabilized by receiving a predetermined quantity of content pieces.

Hereinafter, exemplary embodiments of the present invention will be described in detail with reference to the accompanying drawings.

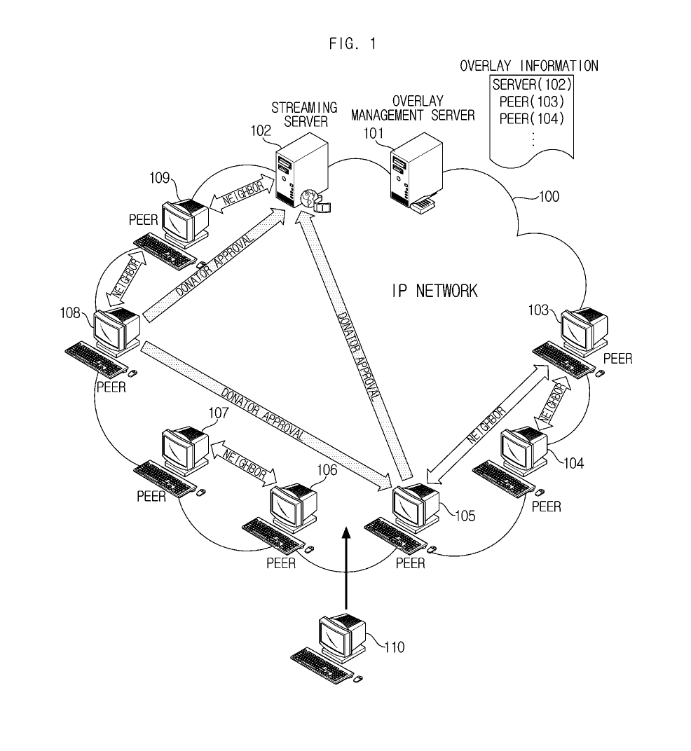

FIG. 1 is a configuration diagram of a mesh type peer-to-peer network in which a relationship between two peers is constituted by neighbors and donators according to an exemplary embodiment of the present invention.

A peer-to-peer network 100 is basically configured on an IP network. Further, according to the exemplary embodiment of the present invention, a multimedia streaming service is provided through the peer-to-peer network 100. The peer-to-peer network 100 according to the exemplary embodiment of the present invention includes an overlay management server 101, a streaming server 102, and peers 103 to 109. In describing the figures, for ease of technical description, reference numerals 103, 104, 105, 106, 107, 108, and 109 will represent first to seventh peers, respectively.

The overlay management server 101 according to the exemplary embodiment of the present invention manages the multimedia streaming service. Further, the overlay management server 101 maintains and manages information on peers that receive the multimedia streaming service. In addition, the overlay management server 101 as a bootstrap node serves to provide to a peer that newly subscribes to service information on other peers that have already subscribed to the corresponding service.

The streaming server 102 according to the exemplary embodiment of the present invention performs the same operation as a general peer. However, the streaming server 102 is different from the general peer in that the streaming server 102 includes a multimedia content.

The peers 103 to 109 according to the exemplary embodiments of the present invention share data on the received multimedia content with other peers. Based on the relationship between the peers, data is bi-directionally exchanged between two or more peers in both directions or data is unidirectionally transmitted or received between two or more peers.

In the exemplary embodiment of the present invention, the neighbor connection relationship is established each between the streaming server 102 and the seventh peer 109, the sixth peer 108 and the seventh peer 109, the fourth peer 106 and the fifth peer 107, the first peer 103 and the third peer 105, and the first peer 103 and the second peer 104. Further, in the exemplary embodiment of the present invention, the donator connection relationship is established each between the third peer 105 and the streaming server 102, the third peer 105 and the sixth peer 108, and the sixth peer 108 and the streaming server 102.

According to the exemplary embodiment of the present invention, in the mesh type peer-to-peer network 100, two peers that have a relationship may transmit and receive the multimedia content as one unit. However, instead of transmitting and receiving the multimedia content as one unit, one multimedia content is divided into several pieces having a predetermined size and thereafter, is preferably transmitted and received as individual pieces.

According to the exemplary embodiment of the present invention, when a new peer 110 newly subscribes to the multimedia streaming service provided in the peer-to-peer network 100, the corresponding new peer 110 serves to receive or transmit the multimedia content piece by establishing the neighbor connection relationship or donator connection relationship with other peers.

As described above, the new peer 110 transmits a service subscription message and an overlay information request message to the overlay management server 101 in order to newly subscribe to the multimedia streaming service provided in the peer-to-peer network 100. In this case, the overlay management server 101 judges whether the new peer 110 is suitable to receive the multimedia streaming service. According to a result of judging whether or not suitable, if suitable, the overlay management server 101 transmits an overlay information message to the new peer 110. The new peer 110 is used to establish the neighbor connection relationship and the donator connection relationship through information on each peer included in the overlay information message.

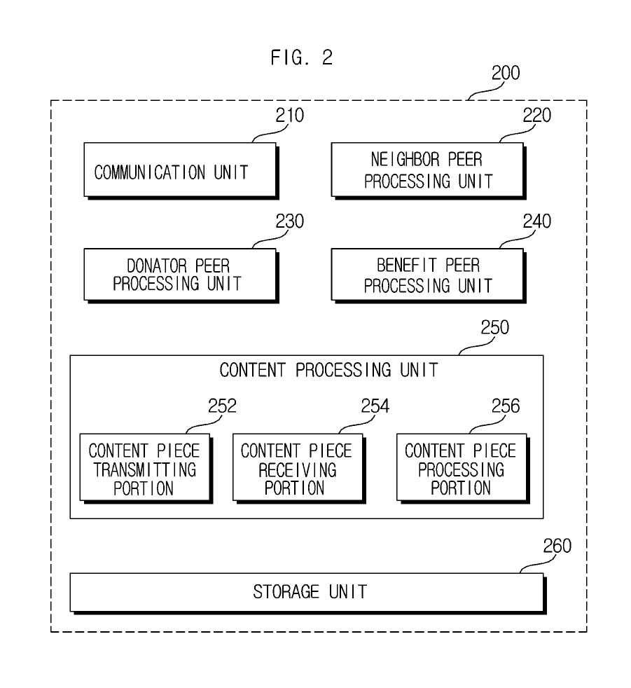

FIG. 2 is a block diagram of a peer for a peer-to-peer based multimedia streaming service according to an exemplary embodiment of the present invention.

A peer 200 according to an exemplary embodiment of the present invention includes a communication unit 210, a neighbor peer processing unit 220, a donator peer processing unit 230, a benefit peer processing unit 240, a content processing unit 250, and a storage unit 260.

The communication unit 210 according to the exemplary embodiment of the present invention serves to communicate with the overlay management server. Further, the communication unit 210 transmits the service subscription message and the overlay information request message to the overlay management server through communicating with the overlay management server. In addition, the communication unit 210 receives the overlay information message which is the information on other peers from the overlay management server through communicating with the overlay management server.

The neighbor peer processing unit 220 according to the exemplary embodiment of the present invention takes charge of establishing the neighbor connection relationship with other peers based on at least one of overlay information and multimedia content piece status information. The neighbor peer processing unit 220 selects the other peer established to have the neighbor connection relationship based on at least one of the overlay information or the multimedia content piece status information, and generates and transmits a neighbor connection relationship establishing message to the other peer. Further, the neighbor peer processing unit 220 determines whether or not to establish the neighbor connection relationship based on the neighbor connection relationship establishing message received from the other peer, and generates and transmits a neighbor connection relationship establishing response message to the other peer according to the determination result.

The neighbor peer processing unit 220 according to the exemplary embodiment of the present invention generates a multimedia content status information request message and transmits the generated message to the other peer in order to establish the neighbor connection relationship.

When the neighbor peer processing unit 220 according to the exemplary embodiment of the present invention receives the multimedia content status information request message from the other peer in order to establish the neighbor connection relationship, the neighbor peer processing unit 220 reads the multimedia content status information stored in the storage unit 260 and transmits the read information to the other peer.

According to another exemplary embodiment of the present invention, the neighbor peer processing unit 220 selects a predetermined multimedia content piece to be received from the other peer established to have the neighbor connection relationship based on at least one of the multimedia content piece status information and the overlay information and requests the selected piece to the other peer. In this case, the neighbor peer processing unit 220 generates and transmits a predetermined multimedia content piece request message to the other peer.

When the neighbor peer processing unit 220 receives the predetermined multimedia content piece request message, the neighbor peer processing unit 220 reads the corresponding multimedia content piece from the storage unit 260 and transmits the read piece to the other peer that requests the read piece. In this case, the neighbor peer processing unit 220 generates and transmits the predetermined multimedia content piece message to the other peer.

When the donator connection relationship with the other peer is established, the donator peer processing unit 230 according to the exemplary embodiment of the present invention operates when this peer serves as a donator peer. The donator peer processing unit 230 determines whether or not the donator peer processing unit 230 serves as the donator based on a donator approval request message from the other peer, and generates and transmits a donator approval notification message through the determination. When the donator peer processing unit 230 receives a new multimedia content piece from the streaming server or the other peer, the donator peer processing unit 230 generates and transmits a new multimedia content piece reception notification message to a benefit peer.

When the donator connection relationship with the other peer is established, the benefit peer processing unit 240 according to the exemplary embodiment of the present invention operates when this peer serves as a benefit peer. The benefit peer processing unit 240 selects a peer established to have the donator connection relationship through a predetermined reference among other peers that have the neighbor connection relationship. Further, the benefit peer processing unit 240 generates a donator approval request message and transmits the generated message to the other peer. The benefit peer processing unit 240 judges whether the benefit peer processing unit 240 needs the corresponding piece depending on the new multimedia content piece reception notification message, and generates a new multimedia content piece request message and transmits the generated message to the other peer.

The content processing unit 250 according to the exemplary embodiment of the present invention includes a content piece transmitting portion 252, a content piece receiving portion 254, and a content piece processing portion 256 and serves to share the content with other peers through each processing portion.

The content piece transmitting portion 252 according to the exemplary embodiment of the present invention serves to transmit the multimedia content piece to other peers. That is, according to requests for predetermined multimedia content pieces from other peers, the content piece transmitting portion 252 serves to transmit the corresponding pieces. In this case, the content piece transmitting portion 252 reads the multimedia content piece requested by the other peer among the multimedia contents stored in the storage unit 260 and transmits the read piece to the other peer.

The content piece receiving portion 254 according to the exemplary embodiment of the present invention serves to receive the multimedia content piece from the other peer. The content piece receiving unit 254 processes to store the received multimedia content piece in the storage unit 260.

The content piece processing portion 256 according to the exemplary embodiment of the present invention serves to restore all multimedia contents by using the multimedia content piece received through the content piece receiving portion 254. That is, the content piece processing portion 256 performs a restoration function so as to locate the received content piece at a corresponding position in all the multimedia contents. That is, the content piece processing portion 256 serves to restore the multimedia content in a type in which all the multimedia contents generated by using the received content piece can be reproduced in this peer.

The storage unit 260 according to the exemplary embodiment of the present invention stores the multimedia content piece received through the content piece receiving portion 254. The storage unit 260 stores the information on the other peer transmitted from the overlay management server. Further, the storage unit 260 stores the multimedia content piece status information possessed by this peer.

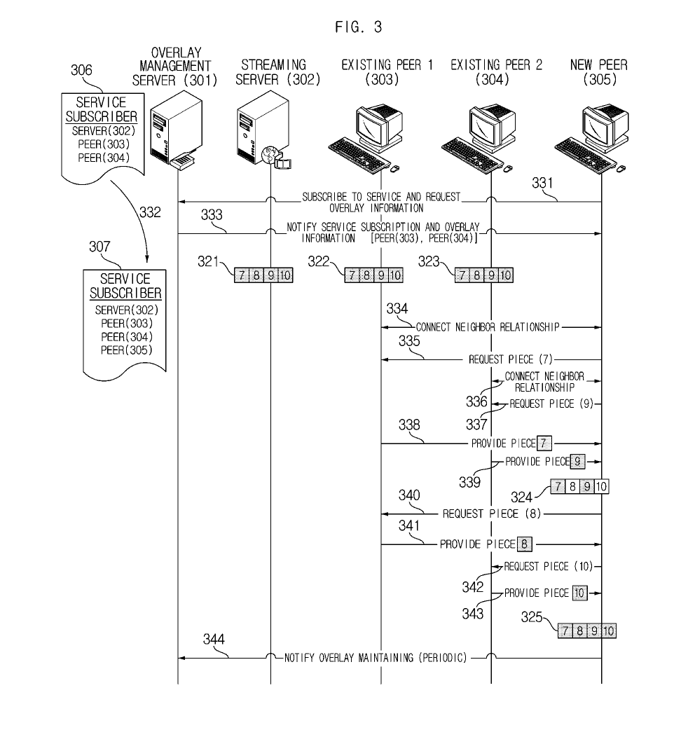

FIG. 3 is a procedure diagram showing an example of a procedure for receiving signaling and a multimedia streaming service for a case where a new peer 305 joins in a multimedia streaming service according to an exemplary embodiment of the present invention.

However, the peer-to-peer network described in the figure includes an overlay management server 301, a streaming server 302, a first existing peer 303, a second existing peer 304, and a new peer 305, but the technical spirit of the present invention is not limited thereto.

In describing the figure, it is presented that each of the streaming server 302, the first existing peer 303, and the second existing peer 304 includes seventh to tenth multimedia content pieces 321, 322, and 323.

The overlay management server 301 has a service subscriber list 306 and information on the streaming server 302, the first existing peer 303, and the second existing peer 304 is included in the service subscriber list 306. However, when a new peer 305 subscribes to a corresponding multimedia streaming service, information on the new peer 305 is also included in a corresponding service subscriber list 307.

Hereinafter, a process in which the new peer 305 subscribes to the multimedia streaming service to receive a multimedia content piece starts to be described.

The new peer 305 that newly subscribes to the multimedia streaming service first transmits a service subscription message and an overlay information request message in order to request service subscription and overlay information to the overlay management server 301 (S331).

The overlay management server 301 allows the new peer 305 to subscribe to the corresponding multimedia streaming service when the new peer 305 meets a predetermined subscription reference. That is, when the overlay management server 301 meets the predetermined subscription reference, the overlay management server 301 adds the new peer 305 to the corresponding multimedia streaming service subscriber list 307 (S332).

When the overlay management server 301 meets the predetermined subscription reference, the overlay management server 301 notifies the subscription of the corresponding service to the new peer 305 (S333). Further, the overlay management server 301 transfers information on each of the first existing peer 303 and the second existing peer 304 which are peers that have already subscribed to the multimedia streaming service which the new peer 305 requests for subscribing in, and information on the streaming server 302 to the new peer 305 (S333). Herein, information on the peer includes a multimedia content identifier possessed by each peer and a piece identifier of the corresponding multimedia content depending on each multimedia content identifier.

The new peer 305 performs connection of a neighbor connection relationship with each of the first existing peer 303 and the second existing peer 304 by referring to the received overlay information (S334 and S336). In this case, the new peer 305 transmits a neighbor connection relationship establishing message to the first existing peer 303 and the second existing peer 304 and the first and second existing peers 303 and 304 judge whether or not to approve the neighbor connection relationship with the new peer 305. Thereafter, when the first and second existing peers 303 and 304 approve the neighbor connection relationship, the first and second existing peers 303 and 304 transmit a neighbor connection relationship establishing response message to the new peer 305. Therefore, the neighbor connection relationship between the new peer 305, and the first existing peer 303 and the second existing peer 304 is established (S334 and S336).

The new peer 305 requests the seventh multimedia content piece and the ninth multimedia content piece with respect to the first existing peer 1 303 and the second existing peer 304, respectively by referring to at least one of overlay information and multimedia content piece status information that are received (S335 and S337). In this case, the seventh multimedia content piece request message and the ninth multimedia content piece request message are generated in the new peer 305 to be transmitted from the new peer 305 to the first and second existing peers 303 and 304.

Based on the multimedia content piece request message, the first existing peer 303 and the second existing peer 304 transmit each of the seventh multimedia content piece and the ninth multimedia content piece to the new peer 305 and when the new peer 305 receives each multimedia content piece (S338 and S339), the new peer 305 updates its own piece status (S324).

The new peer 305 requests the eighth content piece which is short as compared with all multimedia contents to the first existing peer 303 (S340) and receives the corresponding content piece (S341). In this case, the above-mentioned eighth multimedia content piece request message is generated in the new peer 305 to be transmitted in the first existing peer 303. Then, the first existing peer 303 transmits the eighth multimedia content piece message including the eighth multimedia content piece to the new peer 305.

The new peer 305 requests even the tenth multimedia content piece to the second existing peer 304 in the same procedure (S342) and receives the corresponding multimedia content piece (S343). Even in this case, the tenth multimedia content piece request message and the tenth content piece message are used.

As the new peer 305 receives each multimedia content piece, the new peer 305 reflects a corresponding fact to its own multimedia content piece status (S325).

Peers including the new peer 305 periodically notify overlay maintenance to the overlay management server 301 (S344).

In some exemplary embodiments, the new peer 305 serves to transmit and receive the multimedia content piece and transmits its state information by periodically communicating with the overlay management server 301. In this case, the new peer 305 generates a multimedia content piece status information message and transmits the generated message to the overlay management server 301. The state information transmitted to the overlay management server 301 may include a data transmission/reception amount, status information on a present multimedia content piece, and the like.

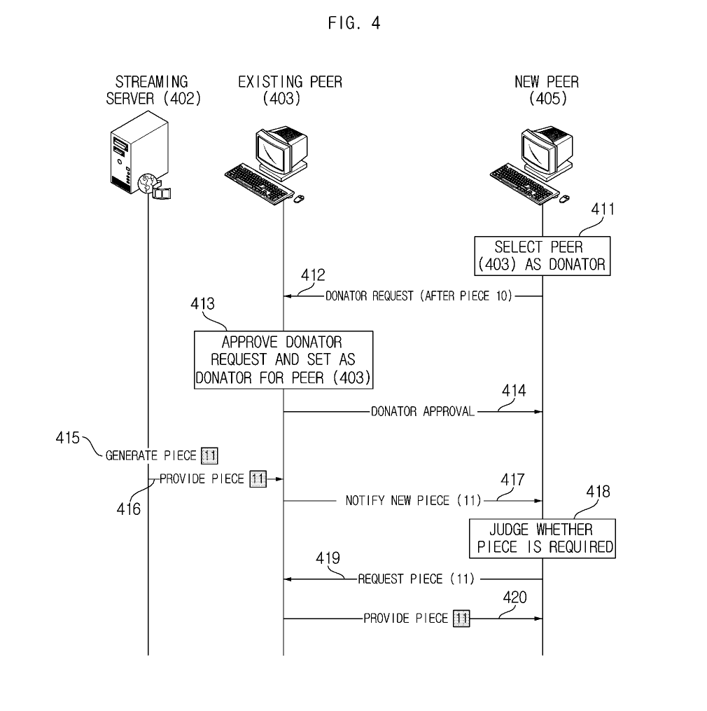

FIG. 4 is a procedure diagram showing an example of a procedure for receiving signaling and a multimedia streaming service for switching a neighbor connection relationship to a donator connection relationship according to an exemplary embodiment of the present invention.

A neighbor connection relationship is established between a new peer 405 and an existing peer 403 through the procedure described in FIG. 3. Further, the peers may transmit and receive the multimedia content piece to and from each other through the neighbor connection relationship.

However, hereinafter, a procedure for switching the neighbor connection relationship to the donator connection relationship will be described. However, in the exemplary embodiment, the new peer 405 requests the multimedia content piece to the existing peer 403 to receive the requested multimedia content piece. Therefore, the new peer 405 is written while being mixed with the benefit peer and the existing peer 403 is written while being mixed with the donator peer, but it is natural that the new peer 405 may become the donator peer and the existing peer 403 may become the benefit peer.

The new peer 405 selects the existing peer 403 as a donator based on a predetermined reference (S411). In this case, the predetermined reference may include information on whether the existing peer 403 operates as the donator of another peer at present.

The new peer 405 transmits a request signal for approval of the donator to the existing peer 403 selected as the donator (S412). In this case, the new peer 405 generates a donator approval request message and transmits the generated message to the existing peer 403 to request for approval of the existing peer 403.

The existing peer 403 judges approval of the donator or not based on the request signal for approval of the donator from the new peer 405, i.e., the donator approval request message. As a result of the judgment, when the existing peer 403 determines to operate as the donator of the new peer 405, the existing peer 403 establishes itself as the donator of the new peer 405 (S413).

The existing peer 403 transmits an approval signal to approve itself as the donator of the new peer 405 to the new peer 405 (S414). In this case, the existing peer 403 generates a donator approval notification message and transmits the generated message to the new peer 405 to notify approval of the existing peer 403. From that time, the existing peer 403 operates as the donator of the new peer 405.

Thereafter, a streaming server 402 has an eleventh multimedia content piece (S415) and when the existing peer 403 as the donator peer receives the eleventh multimedia content piece from the streaming server 402 (S416), the existing peer 403 transmits a notification signal for notifying that the eleventh multimedia content piece is newly received to the new peer 405 (S417). In this case, the existing peer 403 generates a new multimedia content piece reception notification message and transmits the generated message to the new peer 405. The new multimedia content piece notification message may include type information of a newly possessed multimedia content, information indicating which turn of piece in the corresponding content is, and the like.

The new peer 405 parses the new multimedia content piece notification message to judge whether the multimedia content piece newly possessed by the existing peer 403 is needed for the new peer 405. In the exemplary embodiment, as the newly possessed multimedia content piece, the eleventh multimedia content piece in the multimedia content described in FIG. 3 is described (S418). However, if the new peer 405 has already received and possessed the eleventh multimedia content piece from another peer (not shown), the new multimedia content piece notification message that has received is disregarded (S418).

If the new peer 405 needs the eleventh multimedia content piece, the new peer 405 requests the corresponding multimedia content piece to the existing peer 403 as the donator peer (S419). In this case, the new peer 405 generates and transmits a new multimedia content piece request message, i.e., a request message for the eleventh multimedia content piece to the existing peer 403 (S419).

The existing peer 403 generates the multimedia content piece message including the eleventh multimedia content piece and transmits the generated message to the new peer 405, according to the request for the eleventh multimedia content piece from the new peer 405 (S420).

The new peer 405 receives the received eleventh multimedia content piece and couples the received piece with the existing received multimedia content piece to restore the coupled pieces to all multimedia contents. However, when there is a piece required to restore all the multimedia contents in addition to the eleventh multimedia content piece, the new peer 405 may request and possess the needed pieces by using the neighbor connection relationship with the other peer.

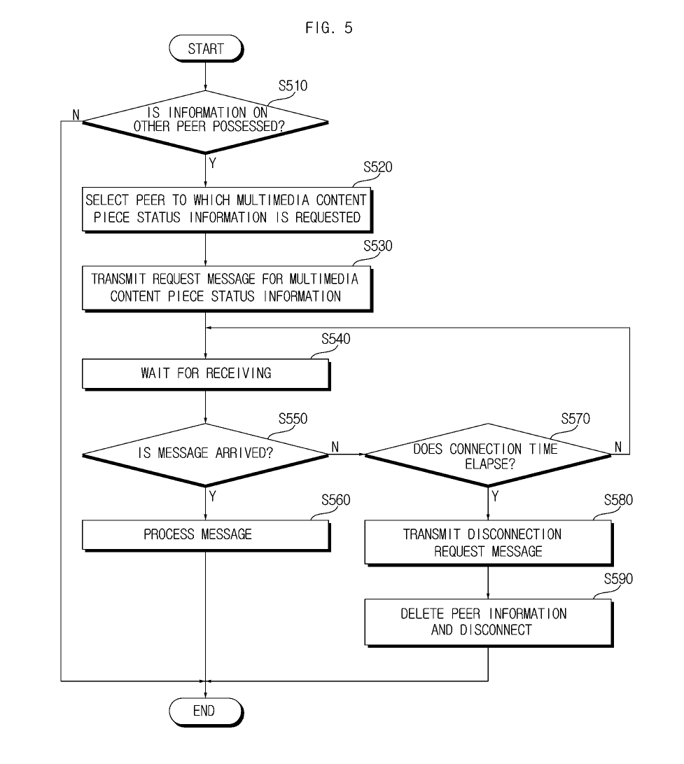

FIG. 5 is a flowchart illustrating a process of establishing a neighbor connection relationship according to an exemplary embodiment of the present invention.

An operation for a peer shown in the flowchart of FIG. 5 is applied similarly to the middle of a multimedia streaming service in addition to the start of an initial multimedia streaming service. Further, the end displayed in the flowchart represents not the end of the multimedia streaming service but the end of processing a neighbor peer. That is, when new overlay information is received from the overlay management server, the processing of the neighbor peer starts again.

Hereinafter, the description will start with reference to FIGS. 1 and 5, in which the new peer 110 serves as the peer that intends to establish the neighbor connection relationship. Further, for convenience of description, it is presented that a peer which the new peer 110 intends to establish the neighbor connection relationship with is a first peer among first to N-th peers on a peer-to-peer network.

When the new peer 110 possesses information on the first to N-th peers on the peer-to-peer network 100 at present (S510), a peer to which the multimedia content piece status information is requested is selected (S520). In this case, the new peer 110 will possess the information on the first to N-th peers based on the overlay information received from the overlay management server 101.

The new peer 110 generates a multimedia content piece status information request message and transmits the message to the first peer 103 in order to request the multimedia piece status information possessed by the first peer 103 (S530).

The new peer 110 transmits the multimedia content piece status information request message to the first peer 103 and thereafter, waits for receiving a multimedia content piece status information message which is a response message to the corresponding request message from the first peer 103 (S540).

When the multimedia content piece status information message arrives while the new peer 110 waits for receiving the corresponding message (S550), the new peer 110 processes the arrived multimedia content piece status information message (S560). That is, the new peer 110 parses the corresponding status information message and thereafter, stores the multimedia content piece status information in a storage unit (not shown). Thereafter, the new peer 110 requests multimedia content pieces which the new peer 110 needs while being possessed by the first peer 103 by using the multimedia content piece status information stored in the storage unit (not shown).

Meanwhile, when the new peer 110 cannot receive the multimedia content piece status information message in spite of waiting for a predetermined connection time (S570), the new peer 110 transmits a disconnection request message to the first peer 103 (S580). Further, the new peer 110 deletes the information on the first peer 103 stored in the storage unit (not shown) and cancels the interactive neighbor connection relationship (S590).

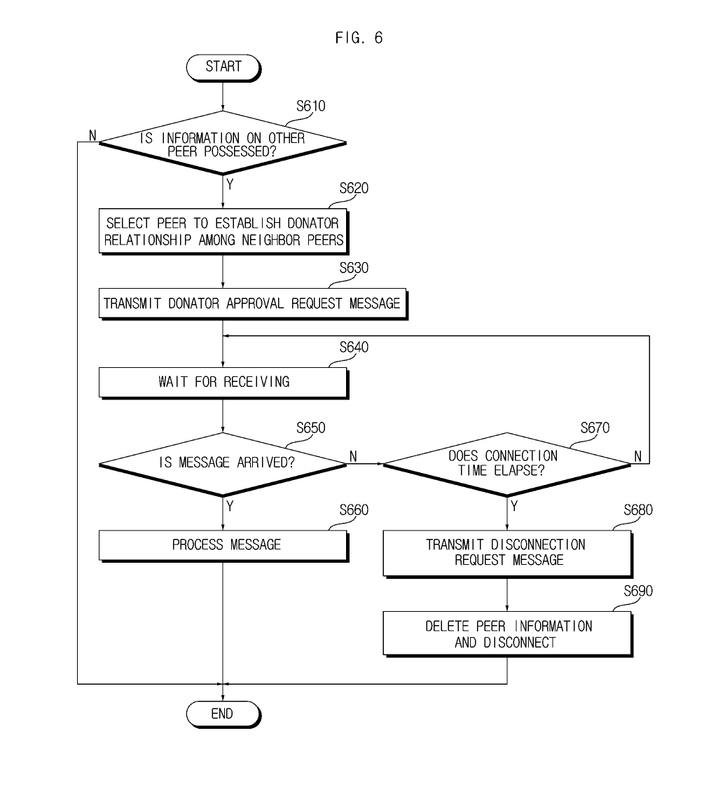

FIG. 6 is a flowchart illustrating a process of establishing a donator connection relationship according to an exemplary embodiment of the present invention.

Hereinafter, the description will start with reference to FIGS. 1 and 6, in which the new peer 110 serves as a peer that intends to establish the donator connection relationship. Further, for convenience of description, it is presented that a peer which the new peer 110 intends to establish the donator connection relationship with is a first peer among first to N-th peers on the peer-to-peer network.

When the new peer 110 possesses the information on the first to N-th peers on the peer-to-peer network 100 at present (S610), a peer which the new peer 110 will establish the donator connection relationship with is selected among one or more peers which the new peer 110 has the neighbor connection relationship with (S620). In the exemplary embodiment, the first peer is set as a peer that the new peer 110 will switch the neighbor connection relationship to the donator connection relationship with. In this case, the new peer 110 may select a peer which the new peer 110 will establish the donator connection relationship with based on the overlay information received from the overlay management server 101.

The new peer 110 generates a donator approval request message and transmits the generated message to the first peer 103 in order to request the donator approval of the first peer 103 (S630).

The new peer 110 transmits the donator approval request message to the first peer 103 and thereafter, waits for receiving a donator approval notification message which is a response message to the corresponding request message from the first peer 103 (S640).

When the donator approval notification message arrives while the new peer 110 waits for receiving the corresponding message (S650), the new peer 110 processes the arrived donator approval notification message (S660). That is, the new peer 110 establishes the donator connection relationship with the first peer 103 based on the corresponding donator approval notification message (S660). Further, thereafter, as the first peer 103 possesses a new multimedia content piece, the new peer 110 may receive the new multimedia content piece from the first peer 103 through a new multimedia content piece reception notification message that is transmitted.

Meanwhile, when the new peer 110 cannot receive the donator approval request message in spite of waiting for a predetermined connection time (S670), the new peer 110 transmits the disconnection request message to the first peer 103 (S680). Further, the new peer 110 deletes the information on the first peer 103 stored in the storage unit (not shown) and cancels the interactive neighbor connection relationship (S690).

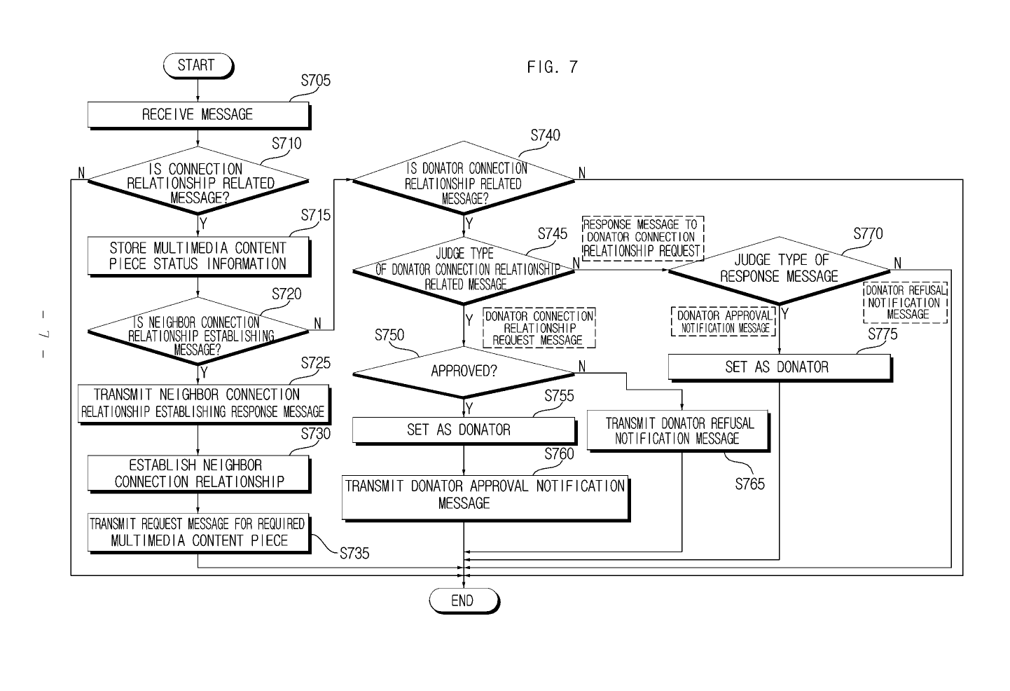

FIG. 7 is a flowchart for illustrating a method for one peer to receive and process a connection relationship related message from the other peer according to an exemplary embodiment of the present invention.

Hereinafter, this diagram will be described by using FIGS. 1 and 7. However, in the description of this diagram, for convenience of description, the first peer receives the connection relationship related message, but it is natural that other peers in addition to the first peer may receive the connection relationship related message. Further, for convenience of description, a second peer 104 is set as a peer that transmits the connection relationship related message, but similarly, it is natural that other peers in addition to the second peer 104 may transmit the connection relationship related message.

First, when the first peer 103 receives a message from the second peer (S705), the first peer 103 verifies whether the received message is the connection relationship related message or the multimedia content piece related message (S710).

According to a verification result, when the received message is the connection relationship related message, the first peer 103 stores the multimedia content piece status information of the second peer 104 included in the connection relationship related message in the storage unit (not shown) (S715).

The first peer 103 verifies whether the connection relationship related message is a neighbor connection relationship establishing message (S720).

According to a verification result, the first peer 103 generates a neighbor connection relationship establishing response message and transmits the generated message to the second peer when the connection relationship related message is the neighbor connection relationship establishing message (S725).

When the neighbor connection relationship is established between the first peer 103 and the second peer 104 as the neighbor connection relationship establishing response message is transmitted (S730), the first peer 103 compares all multimedia with a previously possessed multimedia content piece to generate a request message for a multimedia content piece required to restore all the multimedia contents and transmit the generated request message to the second peer 104 (S735).

Meanwhile, it is verified whether the connection relationship related message is not the neighbor connection relationship establishing message but the donator connection relationship related message (S740). According to a verification result, when the connection relationship related message is the donator connection relationship related message, the first peer 103 judges a type of the corresponding donator connection relationship related message (S745).

When the corresponding donator connection relationship related message is the donator connection relationship request message, the first peer 103 judges whether to approve whether to provide to the previously possessed multimedia content piece to the second peer 104, that is, whether the first peer 103 serves as a donator for the second peer 104 (S750).

According to a judgment result, when the approval is achieved (S750), the first peer 103 establishes itself as the donator for the second peer (S755). Further, the first peer 103 generates a donator approval notification message and transmits the generated message to the second peer 104 (S760). Meanwhile, according to the judgment result, when the approval is not achieved, the first peer 103 generates a donator refusal notification message and transmits the generated message to the second peer 104 (S765).

By judging a type of the donator connection relationship related message in step S745, when the donator connection relationship related message is a response message to the request for the donator connection relationship, the first peer 103 judges the type of the corresponding response message (S770). According to a judgment result, when the corresponding response message is the donator approval notification message, the first peer 103 establishes the second peer 104 as a donator therefor (S775). Further, the first peer 103 searches a multimedia content piece required therefor among multimedia content pieces which the second peer 104 newly possesses to receive the corresponding multimedia content piece from the second peer 104.

Meanwhile, by judging the type of the response message in step S770, when the corresponding response message is the donator refusal notification message, the first peer 103 ends the donator connection relationship establishing operation with the second peer based on the judgment result. Therefore, the first peer 103 may start an operation of starting to establish the donator connection relationship with other peers which may operate as the donator in addition to the second peer 104.

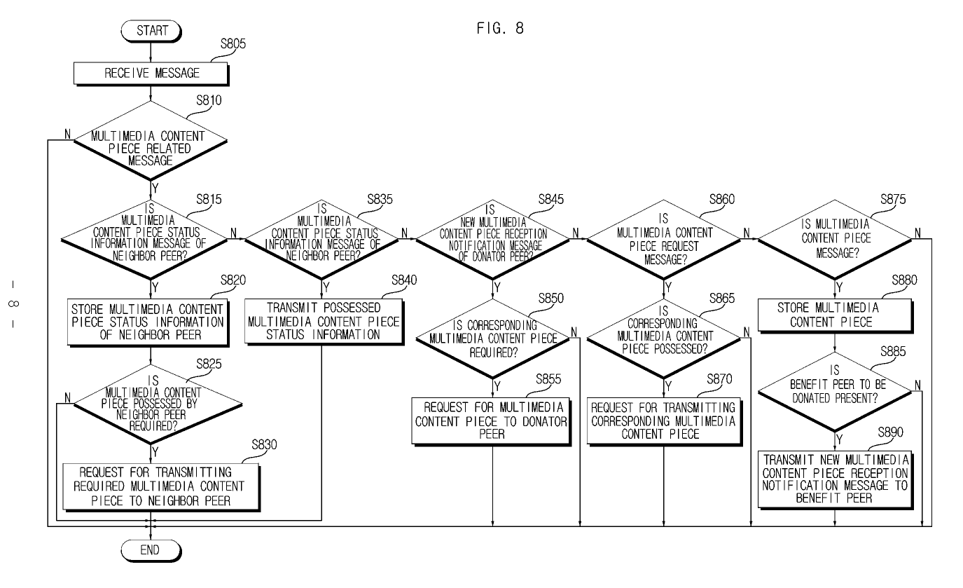

FIG. 8 is a flowchart for illustrating a method for one peer to receive and process a multimedia content piece related message from the other peer according to an exemplary embodiment of the present invention.

Hereinafter, this diagram will be described by using FIGS. 1 and 8. However, in the description of this diagram, for convenience of description, the first peer receives a multimedia content piece related message, but it is natural that other peers in addition to the first peer may also receive the multimedia content piece related message. Further, for convenience of description, the second peer 104 and a streaming server 102 are set as peers that transmit the multimedia content piece related message, but similarly, it is natural that other peers may also transmit the multimedia content piece related message.

First, when the first peer 103 receives a message from the second peer 104 (S805), the first peer 103 verifies whether the received message is the multimedia content piece related message or the connection relationship related message (S810).

According to a verification result, when the received message is the multimedia content piece related message, the first peer 103 verifies whether the corresponding message is the multimedia content piece status information message of the second peer which is the neighbor peer (S815).

According to a verification result, when the corresponding message is the multimedia content piece status information message, the first peer 103 parses the multimedia content piece status information message, reads the multimedia content piece status information of the neighbor peer included therein, and stores the read multimedia content piece status information in the storage unit (not shown) (S820).

The first peer 103 verifies whether a multimedia content piece required therefor is present among the multimedia content pieces possessed by the second peer 104 based on the multimedia content piece status information of the second peer 104 which is the neighbor peer stored in the storage unit (not shown) (S825).

According to a verification result, when the required multimedia content piece is present, the first peer 103 requests for transmitting the required multimedia content piece, to the second peer 104 which is the neighbor peer (S830). In this case, the first peer 103 generates a predetermined multimedia content piece request message required therefor and transmits the generated message to the second peer 104 (S830).

Meanwhile, when the multimedia content piece related message is the multimedia content piece status information request message of the second peer 104 which is the neighbor peer in step S810 (S835), the first peer 103 transmits the multimedia content piece status information stored in the storage unit (not shown) thereof to the second peer 104 (S840). In this case, the first peer 103 generates the multimedia content piece status information message including the multimedia content piece status information and transmits the generated message to the second peer 104 (S840).

When the multimedia content piece related message is a new multimedia content piece reception notification message of a donator peer in step S810 (S845), the first peer 103 judges whether the corresponding multimedia content piece verified through the corresponding notification message is the multimedia content piece required therefor (S850).

According to a judgment result, when the corresponding multimedia content piece is required, the first peer 103 as a benefit peer requests the corresponding multimedia content piece to the second peer 104 as the donator peer (S855). In this case, the first peer 103 generates a predetermined multimedia content piece request message and transmits the generated message to the second peer 104. The second peer 104 generates a predetermined multimedia content piece message including the corresponding multimedia content piece and transmits the generated message to the first peer 103 based on the predetermined multimedia content piece request message.

When the multimedia content piece related message is the multimedia content piece request message in step S810 (S860), the first peer 103 as the donator peer judges whether the corresponding multimedia content piece is possessed (S865). According to a judgment result, when the corresponding multimedia content piece is possessed, the first peer 103 generates the corresponding multimedia content piece message including the corresponding multimedia content piece and transmits the generated message to the second peer 104 as the benefit peer (S870).

Meanwhile, when the multimedia content piece related message is a predetermined multimedia content piece message transmitted from the streaming server 102 to the first peer 103 in step S810 (S875), the first peer 103 parses the predetermined multimedia content piece message to read a predetermined multimedia content piece from the corresponding piece message and store the read piece in the storage unit (not shown) (S880). Further, when there is a benefit peer to which the first peer 103 should donate the predetermined multimedia content piece possessed thereby by serving as the donator peer (S885), the first peer 103 as the donate peer generates a new multimedia content piece reception notification message to the second peer 104 as the benefit peer and transmits the generated message to the second peer 104 as the benefit peer (S890).

An apparatus for receiving and transmitting a multimedia content and a method for receiving and transmitting the multimedia content according to exemplary embodiments of the present invention, for example, can be applied to all fields that use a peer-to-peer network.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for receiving a multimedia content between peers on a peer-to-peer network, comprising:
establishing a neighbor connection relationship which is a relationship to interactively transmit and receive the multimedia content, with the other peer on the peer-to-peer network;
establishing a donator connection relationship to receive the multimedia content from the other peer, based on a donator approval request message transmitted to the other peer;
receiving a multimedia content piece related message from the other peer based on the established donator connection relationship; and
receiving a required multimedia content piece from the other peer according to a result of parsing the multimedia content piece related message.

2. The method of claim 1, wherein when the multimedia content piece related message is a new multimedia content piece reception notification message, the receiving of the multimedia content piece based on the donator connection relationship includes:
judging whether a new multimedia content piece is required; and
transmitting a new multimedia piece request message to the other peer when the new multimedia content piece is required.

3. The method of claim 1, wherein the establishing of the neighbor connection relationship includes:
transmitting an overlay information request message to an overlay management server;
parsing a received overlay information message based on the overlay information request message; and
establishing the neighbor connection relationship with the other peer by referring to overlay information acquired by parsing the received overlay information message.

4. The method of claim 1, further comprising receiving a predetermined multimedia content piece from the other peer based on the neighbor connection relationship.

5. A method for transmitting a multimedia content between peers on a peer-to-peer network, comprising:
establishing a neighbor connection relationship which is a relationship to interactively transmit and receive the multimedia content, with the other peer on the peer-to-peer network;
receiving a donator approval request message from the other peer;
judging whether to serve as a donator based on the received donator approval request message;
transmitting a donator approval notification message to the other peer and establishing a donator connection relationship to provide the multimedia content to the other peer when serving as the donator is judged; and
transmitting a multimedia content piece to the other peer based on the donator connection relationship.

6. The method of claim 5, wherein the transmitting to the other peer includes:
receiving a new multimedia content piece from a streaming server or the other peer;
transmitting a reception notification message for the new multimedia content piece to the other peer; and
transmitting the new multimedia content piece to the other peer when a request message for the new multimedia content piece is received based on the reception notification message.

7. An apparatus for processing a multimedia content on a peer-to-peer network, comprising:
a neighbor peer processing unit establishing a neighbor connection relationship which is a relationship to interactively transmit and receive the multimedia content, with the other peer on the peer-to-peer network;
a benefit peer processing unit transmitting a donator approval request message to the other peer having the neighbor connection relationship; and
a content processing unit processing the multimedia content received through the donator connection relationship when a donator connection relationship to receive the multimedia content from the other peer through the donator approval request message is established with the other peer.

8. The apparatus of claim 7, wherein the content processing unit includes a content piece processing unit restoring a multimedia content piece received from the other peer to all multimedia contents.

9. The apparatus of claim 7, further comprising a donator peer processing unit judging whether to approve a donator based on the donator approval request message received from the other peer having the neighbor connection relationship and transmitting the donator approval notification message to the other peer when serving as the donator is approved according to a judgment result.

10. The apparatus of claim 7, wherein the neighbor peer processing unit requests a required multimedia content piece to the other peer based on at least one information among multimedia content piece status information possessed by the other peer.
